(19) United States
(12) Patent Application Publication
(10) Pub. No.: US 2026/0148076 A1
(43) Pub. Date: May 28, 2026

(54) DISTRIBUTED TRANSFORMER-BASED LARGE LANGUAGE MODEL (LLM) TRAINING METHOD FOR MOBILE DEVICE

(71) Applicant: ZHEJIANG UNIVERSITY, Hangzhou (CN)

(72) Inventors: Qianqian YANG, Hangzhou (CN); Yuanchao SHU, Hangzhou (CN); Yuhao CHEN, Hangzhou (CN); Yuxuan YAN, Hangzhou (CN)

(73) Assignee: ZHEJIANG UNIVERSITY, Hangzhou (CN)

(21) Appl. No.: 19/389,113

(22) Filed: Nov. 14, 2025

(30) Foreign Application Priority Data
Nov. 28, 2024 (CN) 202411723727.2

(51) Int. Cl. G06N 3/0895

(52) U.S. Cl. CPC G06N 3/0895

(57) ABSTRACT

An efficient and robust distributed transformer-based large language model (LLM) training method for a mobile device is provided. During distributed training of a transformer-based LLM, for each mobile device participating in the training, computing resources of various heterogeneous processors are collected. Based on this, different quantities of self-attention heads in a transformer are allocated to the heterogeneous processors for parallel computing, thereby accelerating computation of a self-attention mechanism in the transformer-based LLM on the mobile device. A fault-tolerant recovery process handles in advance a predictable fault caused by a dynamic nature of the mobile device during the distributed training, enabling the distributed training to complete fault-tolerant recovery without fault-induced interruption. The training method fully utilizes the dynamic nature of the mobile device and computing resources of a plurality of processors of the mobile device to achieve efficient and robust distributed training of a transformer model on the mobile device.

### CROSS REFERENCE TO THE RELATED APPLICATIONS

This application is based upon and claims priority to Chinese Patent Application No. 202411723727.2, filed on Nov. 28, 2024, the entire contents of which are incorporated herein by reference.

### TECHNICAL FIELD

The present disclosure relates to the technical field of artificial intelligence for mobile devices, and specifically, to an efficient and robust distributed transformer-based large language model (LLM) training method for a mobile device.

### BACKGROUND

Edge computing can bring low latency, high security, and high customization to deep learning applications. With the widespread application of a transformer-based large language model (LLM), users expect a neural network model to possess domain-specific knowledge, making a demand for a customized neural network model more prominent. Therefore, training a neural network on a mobile device is of great significance for customizing the deep learning applications. Federated learning is a typical distributed training architecture for the mobile device. Each mobile device independently trains a complete neural network model, while an edge server performs weights aggregation and distribution for the neural network. However, with the release of the transformer-based LLM, the neural network model has hundreds of billions of parameters. Due to limited memory, a single device can no longer complete training of a neural network model with at least tens of billions of parameters, which imposes certain limitations on a federated learning architecture. To address a problem of the limited memory on the mobile device, a feasible solution is to split the neural network model into a plurality of sub-models, which are then deployed on a plurality of mobile devices for distributed collaborative training.

In the distributed training, since a wireless network is used for communication between mobile devices, faults such as network disconnection and device crash may occur during the training. Considering a dynamic nature of the mobile device, situations like device battery depletion or early device exit may also arise, all of which can lead to interruptions to the distributed training on the mobile device. When such situations occur, a fault-tolerant recovery strategy can be used to resume the training after the interruptions. Nevertheless, a fault caused by the dynamic nature of the mobile device can be predicted in advance, and current fault-tolerant recovery strategies cannot leverage the dynamic nature of the mobile device to reduce a time overhead of fault-tolerant recovery.

In addition, although a self-attention mechanism in the transformer-based LLM is characterized by parallelizable computing, existing distributed training methods still fail to fully utilize a computing resource of the mobile device to accelerate computation of the self-attention mechanism. Unlike a server on which a graphics processing unit (GPU) has a superior parallel computing capability compared with a central processing unit (CPU), a GPU on the mobile device has a computing capability similar to or even weaker than the CPU. This means that parallel computing of a plurality of processors can be applied on the mobile device to accelerate the computation of the self-attention mechanism. However, on one hand, current neural network computing frameworks that support the mobile device can only perform computation on one type of processor at the same time. As a result, neural network computation on the mobile device is often completed on the CPU, and the computing resource of the mobile device is not fully utilized. On the other hand, it is necessary to allocate different quantities of attention heads in the self-attention mechanism to various processors based on heterogeneous computing power of the processors, so as to minimize parallel computing time of a transformer.

Therefore, for the distributed training of the transformer-based LLM on a mobile device, how to fully leverage the computing resource and the dynamic nature of the mobile device to improve efficiency and robustness of the distributed training is a task that urgently needs to be studied.

### SUMMARY

The present disclosure is intended to address the aforementioned technical problems existing in the prior art, and provide an efficient and robust distributed transformer-based LLM training method for a mobile device, to achieve efficient and robust distributed transformer-based LLM training on the mobile device through an on-device multi-processor scheduling module and a proactive fault-tolerant recovery module.

The present disclosure resolves the aforementioned technical problems by using the following technical solutions: An efficient and robust distributed transformer-based LLM training method for a mobile device is provided, where there are N mobile devices, including a central mobile device and N−1 collaborative mobile devices, and the N mobile devices are connected through a network; and the training method includes: splitting a transformer-based LLM into N sub-models, and deploying the N sub-models on the N mobile devices respectively to perform distributed collaborative training; if a mobile device is a multi-processor mobile device, allocating, by the mobile device, an attention head to each heterogeneous processor for computation; in a forward propagation process of the collaborative training: when 1≤i≤N, transmitting, by an i^{th} mobile device, an intermediate output computed through local forward propagation to an (i+1)^{th} mobile device; or if i=N, computing, by an i^{th} mobile device, a loss, and executing backpropagation to send a gradient to an (i−1)^{th} mobile device; in a backpropagation process of the collaborative training, when 1≤i≤N, transmitting, by the i^{th} mobile device, a gradient computed through backpropagation to an (i−1)^{th} mobile device; or if i=1, performing, by the i^{th} mobile device, training for a next data batch; and when a collaborative mobile device needs to exit the distributed training, selecting a suitable mobile device according to a fault-tolerant recovery method to replace the collaborative mobile device that needs to exit the distributed training and continue the training.

The central mobile device possesses original training data and is responsible for managing an entire distributed training process and calculating a locally-allocated sub-model. Meanwhile, the collaborative mobile devices are responsible for calculating respective locally-allocated sub-models.

Preferably, the allocating an attention head to each heterogeneous processor for computation is as follows:
if there are K attention heads in the mobile device, before the distributed training, searching for all processors available for neural network computation on the mobile device, where there are a total of M processors; measuring time for each of the M processors to compute k attention heads, denoting the time as T_{k_j}, where 1≤j≤M, 1≤k≤K, and if a heterogeneous processor supports a plurality of neural network computation libraries, shortest computation time among the plurality of neural network computation libraries is selected as the T_{k_j}, for example, if a GPU of a mobile phone supports using computing libraries OpenCL and Vulkan for the neural network computation, relatively shorter computation time in the OpenCL and the Vulkan is selected herein;
initializing a lower bound l as 0 and an upper bound r as a minimum value of time T_{K_j} required for each heterogeneous processor to compute the K attention heads; and in each iteration, computing a median value mid=(l+r)/2, and then checking whether there is an allocation scheme under which total attention head computation time is less than or equal to (mid+ε)×110%, where because each processor executes attention head computation in parallel, the total computation time is equal to computation time of a slowest processor plus time for the processor to copy data to a CPU, and therefore, a time requirement is appropriately relaxed; and ε represents a computation time deviation threshold, which is determined artificially based on a model; and defining an allocation scheme S={(j,Oⱼ)|j=1, . . . , M; k=1, . . . K}, where a specific checking method is as follows:
initializing a current allocation scheme S′={ }; for a j^{th} processor, finding a minimum value of |T_{k_j}−mid|, denoting a quantity k that is of self-attention heads and corresponds to the minimum value as Oⱼ, in other words, allocating the k self-attention heads to the j^{th} processor, and inserting (j,Oⱼ) into the S′; if the minimum value of the |T_{k_j}−mid| exceeds the specified threshold ε, setting Oⱼ=0, it is indicated that the processor performs computation too fast or too slow; if a sum of all values of the Oⱼ is greater than or equal to K, it is indicated that the allocation scheme S′ is feasible, updating an original allocation scheme to the S′, and setting the upper bound r to mid−σ; or if a sum of all values of the Oⱼ is less than K, it is indicated that the allocation scheme is infeasible, updating the lower bound to mid+σ, and then re-searching for an allocation scheme, where σ represents a relatively small value to avoid an infinite loop, which is generally set to 0.1% of the upper bound l; and terminating the iteration when l>r.

In parallel computing, the total computation time depends on the slowest processor. Therefore, in this solution, it is necessary to ensure that computation time of each processor is as close as possible to the mid. Thus, neither too short computation time nor too long computation time is a reasonable allocation scheme.

Preferably, when a collaborative mobile device needs to exit the distributed training due to a dynamic event, the mobile device d_{q} sends a notification to the central mobile device in advance by α time; after receiving the notification, the central mobile device searches for an idle mobile device capable of participating in the training in the network through broadcasting; if there is no idle mobile device in the network, a conventional passive fault-tolerant recovery algorithm is used to perform fault-tolerant recovery on the training process, where the conventional passive fault-tolerant recovery algorithm includes an algorithm based on weights backup, an algorithm based on model redistribution, and the like, and for details, reference is made to Li P, Koyuncu E, Seferoglu H. Respipe: Resilient model-distributed dnn training at edge networks[C]//ICASSP 2021-2021 IEEE International Conference on Acoustics, Speech and Signal Processing (ICASSP). IEEE, 2021: 3660-3664., or Chen Y, Yang Q, He S, et al. Ftpipehd: A fault-tolerant pipeline-parallel distributed training approach for heterogeneous edge devices[J]. IEEE Transactions on Mobile Computing, 2023, 23(4): 3200-3212., or Ye S, Zeng L, Chu X, et al. Asteroid: Resource-Efficient Hybrid Pipeline Parallelism for Collaborative DNN Training on Heterogeneous Edge Devices[C]//Proceedings of the 30th Annual International Conference on Mobile Computing and Networking. 2024: 312-326.; or each idle mobile device if available sends a computing power characterization vector and a remaining battery power percentage to the central mobile device, where a computing power characterization vector of a u^{th} idle mobile device is hᵤ, and a remaining battery power percentage of the u^{th} idle mobile device is bᵤ; the hᵤ characterizes computing power of the mobile device through computation time of a transformer module, and is defined as hᵤ={t_{u,1}, t_{u,2}, . . . , t_{u,L}}, where t_{u,n} represents time required to compute n layers of transformers; and the bᵤ is a decimal between 0 and 1, with a larger value indicating more remaining battery power of the mobile device; and based on the hᵤ and the bᵤ, the central device evaluates compatibility of the idle mobile device based on a device compatibility (DC) criterion, which is defined as follows:

$$D {C}_{u} = \frac{p * {\hat{b}}_{u}}{{\hat{H}}_{u} + η} ,$$

where DCᵤ represents the compatibility of the u^{th} idle device; p represents a percentage of a remaining training process, and is equal to [Bᵣ+(T−T_{cur})*B]*B/T, where T represents a total quantity of training rounds, B represents a total quantity of data batches, T_{cur} represents a current training round, and Bᵣ represents a remaining quantity of data batches in the current training round; η represents a small constant greater than 0, where a denominator is prevented from becoming zero; Ĥᵤ represents normalized computing power of the device, and is equal to (Hᵤ−Hₘᵢₙ)/(Hₘₐₓ−Hₘᵢₙ), where Hᵤ is obtained by summing all elements in the hᵤ, and Hₘₐₓ and Hₘᵢₙ respectively represent a maximum value and a minimum value among all values of the Hᵤ; and \hat{b}ᵤ represents normalized battery power of the device, and is equal to (bᵤ−bₘᵢₙ)/(bₘₐₓ−bₘᵢₙ), where bₘₐₓ represents a maximum value among all values of the bᵤ, and bₘᵢₙ represents a minimum value among all the values of the bᵤ; the central mobile device selects a most suitable mobile device dₛ (with a largest DCᵤ value) from a local area network based on the DC criterion to replace the mobile device d_{q}; the above process is carried out simultaneously with the collaborative training and does not interrupt the training; subsequently, the training is temporarily interrupted, and the d_{q} transmits weights of a transformer sub-model to the dₛ; after the weights are completely transmitted, the central mobile device broadcasts a device replacement message to all devices participating in the training; and finally, the distributed training resumes normally. The DC criterion takes into account a computing resource and remaining battery power of the mobile device when the mobile device is selected, in order to ensure stability of the training. At the beginning of the training, a value of the p is relatively large, and the DC criterion focuses more on the remaining battery power of the mobile device; as the training progresses, the value of the p gradually decreases, and the DC criterion pays more attention to computing power of the mobile device.

Preferably, the α time for sending the notification to the central mobile device in advance is longer than time required for the central device to select a most suitable replacement device from devices in the local area network.

Preferably, the dynamic event of the mobile device includes battery exhaustion and active exit from the local area network.

Preferably, the mobile devices are intelligent terminals with computing capabilities, including mobile phones, watches, microcontrollers, cameras, laptops, and desktop computers.

Preferably, processors of the mobile devices are chips with computing capabilities, including CPUs, GPUs, and neural network processing units (NPUs). A homogeneous processor is a special case of a heterogeneous processor. The solution in the present disclosure is also applicable to the homogeneous processor, and resulting allocation may be even allocation.

Substantial effects brought by the present disclosure are as follows: (1) Based on computing power of each heterogeneous processor in an edge device, a multi-processor scheduling method can allocate attention heads in a transformer-based LLM to a plurality of processors for parallel computing, thereby accelerating computation of an LLM on the edge device; (2) A proactive fault-tolerant recovery method enables collaborative training to address in advance a training interruption caused by a dynamic event of a mobile device, thereby reducing a time overhead caused by fault-tolerant recovery, and improving robustness of a collaborative training method.

### BRIEF DESCRIPTION OF THE DRAWINGS

FIG. 1 is a schematic diagram of an efficient and robust distributed transformer-based LLM training method for a mobile device according to the present disclosure;

FIG. 2, FIG. 3, and FIG. 4 schematically show computation performed by an on-device multi-processor scheduling module in an efficient and robust distributed transformer-based LLM training method for a mobile device according to the present disclosure; and

FIG. 5 is a schematic diagram of a proactive fault-tolerant recovery module in an efficient and robust distributed transformer-based LLM training method for a mobile device according to the present disclosure.

### DETAILED DESCRIPTION OF THE EMBODIMENTS

The present disclosure is further specifically described below with reference to the accompanying drawings through embodiments.

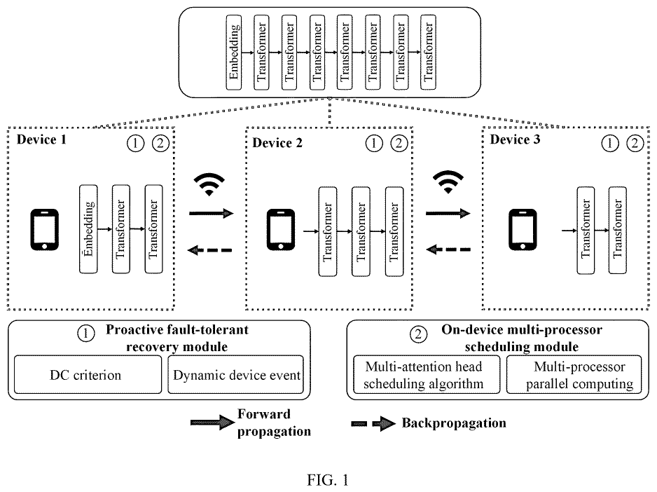

Embodiment: An efficient and robust distributed transformer-based LLM training method for a mobile device is implemented by three mobile devices, as shown in FIG. 1. Among them, device 1 is a central mobile device and possesses to-be-trained original data; and device 2 and device 3 are collaborative mobile devices. The three mobile devices are connected to a same router, which are identified by IP addresses and perform communication through a wireless network and a HyperText Transfer Protocol (HTTP) request. Each mobile device is installed with an application for implementing the present disclosure, and uses a mobile neural network (MNN) as a neural network computing framework. The MNN is a computing framework that supports neural network training on the mobile device.

The central mobile device splits an 8-layer transformer-based LLM into three sub-models and deploys them on the three mobile devices respectively. The device 1 is responsible for computing a sub-model of layers 1 to 3, the device 2 is responsible for computing a sub-model of layers 4 to 6, and the device 3 is responsible for computing a sub-model of layers 7 and 8. After the original data is input into the device 1, the sub-model on the device 1 performs forward propagation. Computed feature data is sent to the device 2 to continue forward propagation, and a data label required for loss computation is also sent to the device 3. Subsequently, the device 3 performs forward propagation. After completing the forward propagation, the device 3 uses a loss function to compute a corresponding loss, performs backpropagation to update model weights, and sends gradient data to the device 2 to continue backpropagation. Then the device 1 performs backpropagation, realizing distributed collaborative training.

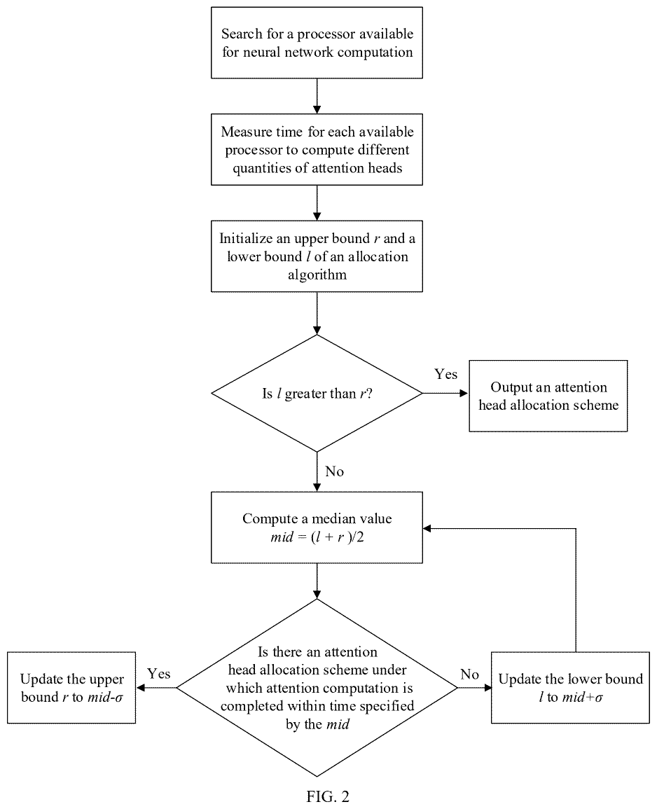

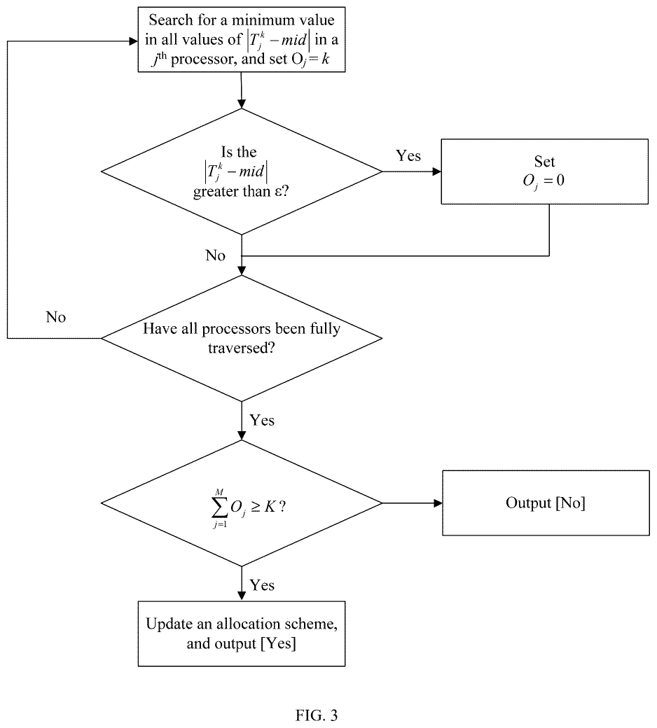

A workflow of an on-device multi-processor scheduling module on each mobile device is shown in FIG. 2 and FIG. 3. As shown in FIG. 2, a process of allocating an attention head to each heterogeneous processor for computation is as follows:

If there are K attention heads in the mobile device, before the distributed training, all processors available for neural network computation are searched for on the mobile device, where there are a total of M processors; time for each of the M processors to compute a plurality of attention heads is measured, denoting the time as T_{k_j}, where 1≤j≤M and 1≤k≤K. If a heterogeneous processor supports a plurality of neural network computation libraries, shortest computation time among the plurality of neural network computation libraries is selected as the T_{k_j}.

Lower bound l is initialized as 0, and upper bound r is initialized as a minimum value of time T_{K_j} required for each heterogeneous processor to compute the K attention heads. In each iteration, median value mid=(l+r)/2 is computed, and then whether there is an allocation scheme under which total attention head computation time is close to the mid is checked. As shown in FIG. 3, a specific checking method is as follows:

For a j^{th} processor, a minimum value of |T_{k_j}−mid| is found, and a quantity k that is of self-attention heads and corresponds to the minimum value is denoted as Oⱼ, in other words, the k self-attention heads are allocated to an i^{th} processor in the allocation scheme. If the minimum value of the |T_{k_j}−mid| exceeds the specified threshold ε, Oⱼ=0 is set, it is indicated that the processor performs computation too fast or too slow. If a sum of all values of the Oⱼ is greater than or equal to K, it is indicated that the allocation scheme is feasible, an original allocation scheme is updated, and the upper bound r is set to mid−σ. If a sum of all values of the Oⱼ is less than K, it is indicated that the allocation scheme is infeasible, the lower bound is updated to mid+σ, and then an allocation scheme is searched for, where a represents a relatively small value to avoid an infinite loop. The iteration is terminated when l>r.

FIG. 4 shows an example of allocating six attention heads between a CPU and a GPU. The device 1 is taken as an example. Assuming that a self-attention mechanism of the trained LLM in this embodiment has six attention heads, before the training, the device 1 finds local processors CPU and GPU available for the neural network computation and then separately measures time required for the local CPU and GPU to compute k attention heads, where k=1, 2, . . . , and 6. After the measurement is completed, the module initializes the lower bound as 0 and the upper bound as a minimum value among time required for the CPU and the GPU to compute six attention heads. Subsequently, through an attention head allocation algorithm based on binary search, an optimal allocation scheme is obtained, that is, four attention heads are allocated to the GPU, and the remaining two attention heads are allocated to the CPU. The GPU and the CPU perform parallel computing on the attention heads, thereby accelerating attention head computation.

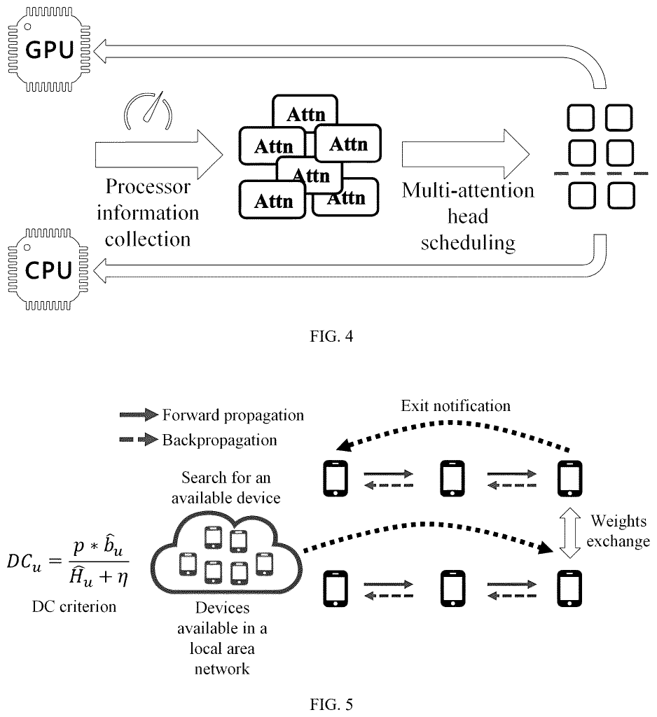

A proactive fault-tolerant recovery mechanism of a hybrid fault-tolerant recovery module for each edge device is shown in FIG. 5. When the device 3 needs to exit the training, the device 3 sends a notification to the device 1 in advance. The device 1 then performs broadcasting in a local area network to search for an available device. If there is no available device, the device 1 rolls back to a passive fault-tolerant recovery algorithm. Otherwise, the device 1 collects remaining battery power percentage b and computing power characterization vector h of each available device, calculates remaining progress p of the collaborative training, computes DC of each available device based on the above data, and selects a device with a highest DC value as a replacement device. After the replacement device is found, the training is temporarily interrupted. The device 1 broadcasts a list of devices participating in the collaborative training to all collaborative edge devices, and the device 3 sends weights of the local sub-model to the replacement device. After the replacement device initializes a corresponding sub-model and loads the weights sent by the device 3, the collaborative training resumes normally, and the device 3 can exit the training.

A computing power characterization vector of a u^{th} idle mobile device is hᵤ, and a remaining battery power percentage of the u^{th} idle mobile device is bᵤ. The hᵤ characterizes computing power of the mobile device through computation time of a transformer module, and is defined as hᵤ={t_{u,1}, t_{u,2}, . . . , t_{u,L}}, where t_{u,n} represents time required to compute n layers of transformers; and the bᵤ is a decimal between 0 and 1, with a larger value indicating more remaining battery power of the mobile device. Based on the hᵤ and the bᵤ, the central device evaluates compatibility of the idle mobile device based on a DC criterion, which is defined as follows:

$$D {C}_{u} = \frac{p * {\hat{b}}_{u}}{{\hat{H}}_{u} + η}$$

where p represents a percentage of the remaining training process, and is equal to [Bᵣ+(T−T_{cur})*B]*B/T, where T represents a total quantity of training rounds, B represents a total quantity of data batches, T_{cur} represents a current training round, and Bᵣ represents a remaining quantity of data batches in the current training round; η represents a small constant greater than 0, where a denominator is prevented from becoming zero; Ĥᵤ represents normalized computing power of the device, and is equal to (Hᵤ−Hₘᵢₙ)/(Hₘₐₓ−Hₘᵢₙ), where Hᵤ is obtained by summing all elements in the hᵤ, and Hₘₐₓ and Hₘᵢₙ respectively represent a maximum value and a minimum value among all values of the Hᵤ; and \hat{b}ᵤ represents normalized battery power of the device, and is equal to (bᵤ−bₘᵢₙ)/(bₘₐₓ−bₘᵢₙ). The central mobile device selects most suitable mobile device dₛ from the local area network based on the DC criterion to replace mobile device d_{q} to be exited.

The efficient and robust distributed transformer-based LLM training method for a mobile device has advantages such as low latency and high robustness. To verify the advantages of the present disclosure, the present disclosure conducts practical experiments on a distributed collaborative training system composed of three mobile phones: Redmi K50, Redmi 10× Pro, and Xiaomi 10 Lite. Time required to train ten data batches (a batch size is set to 4 considering limited memory of the mobile device) on each of two transformer-based LLMs BERT-Base and GPT-2-Medium is measured. The experiments show that after the on-device multi-processor scheduling module is used, time required for the three devices to collaboratively train the two models is 120.49 seconds and 676.06 seconds, respectively. For comparison, when the on-device multi-processor scheduling module is not used, time required for the three devices to collaboratively train the two models is 205.19 seconds and 1211.727 seconds, respectively.

The present disclosure also compares time overheads of the proactive fault-tolerant recovery algorithm and the passive fault-tolerant recovery algorithm on the distributed collaborative training system. By simulating an active exit event of the device 2 during the training of the BERT-Base, execution time of different processes in a fault-tolerant recovery process is measured, as shown in Table 1.

TABLE 1

| | Time | | Time |
|---|---|---|---|
| Passive fault- | overhead | Proactive fault- | overhead |
| tolerant recovery | (millisecond) | tolerant recovery | (millisecond) |
| Fault detection | 4631 | Device search | 6325 |
| Weights redistribution | 5764 | Device replacement | 23168 |
| Re-training | 4439 | Re-training | 4245 |
| Total overhead of | 16834 | Total overhead of | 4487 |
| the passive fault- | | the proactive fault- | |
| tolerant recovery | | tolerant recovery | |

As can be seen from Table 1, since the device search and device replacement processes in the proactive fault-tolerant recovery are performed synchronously with the training, time for the device search and device replacement processes is not included in a total time overhead. It is evident that the total time overhead of the proactive fault-tolerant recovery is much lower than that of the passive fault-tolerant recovery, highlighting high efficiency of the present disclosure in fault-tolerant recovery.

The specific embodiments described herein are merely intended to illustrate the spirit of the present disclosure by way of example. A person skilled in the art can make various modifications or supplements to the specific embodiments described or replace them in a similar manner, but it may not depart from the spirit of the present disclosure or the scope defined by the appended claims.

Although terms such as “mobile device”, “processor”, and “fault-tolerant recovery” are used extensively herein, the possibility of using other terms is not excluded. The terms are only intended to describe and explain the essence of the present disclosure more conveniently. It is contrary to the spirit of the present disclosure to interpret these terms as any additional limitation.

1. A distributed transformer-based large language model (LLM) training method for a mobile device, wherein there are N mobile devices, comprising a central mobile device and N−1 collaborative mobile devices, and the N mobile devices are connected through a network; and the training method comprises: splitting a transformer-based LLM into N sub-models, and deploying the N sub-models on the N mobile devices respectively to perform distributed collaborative training; if a mobile device is a multi-processor mobile device, allocating, by the mobile device, an attention head to each heterogeneous processor for computation; in a forward propagation process of the collaborative training: when 1≤i<N, transmitting, by an i^{th} mobile device, an intermediate output computed through local forward propagation to an (i+1)^{th} mobile device; or if i=N, computing, by an i^{th} mobile device, a loss, and executing backpropagation to send a gradient to an (i−1)^{th} mobile device; in a backpropagation process of the collaborative training, when 1≤i<N, transmitting, by the i^{th} mobile device, a gradient computed through backpropagation to an (i−1)^{th} mobile device; or if i=1, performing, by the i^{th} mobile device, training for a next data batch; and when a collaborative mobile device needs to exit the distributed training, selecting a suitable mobile device according to a fault-tolerant recovery method to replace the collaborative mobile device that needs to exit the distributed training and continue the training; wherein
the allocating the attention head to each heterogeneous processor for computation is as follows:
when there are K attention heads in the mobile device, before the distributed training, searching for all processors available for neural network computation on the mobile device, wherein there are a total of M processors; measuring time for each of the M processors to compute k attention heads, denoting the time as T_{k_j}, wherein 1≤j≤M, 1≤k≤K, and if a heterogeneous processor supports a plurality of neural network computation libraries, shortest computation time among the plurality of neural network computation libraries is selected as the T_{k_j}; and
initializing a lower bound l as 0 and an upper bound r as a minimum value of time T_{K_j} required for each heterogeneous processor to compute the K attention heads; and in each iteration, computing a median value mid=(l+r)/2, and then checking whether there is an allocation scheme under which a total attention head computation time is less than or equal to (mid+ε)×110%, wherein ε represents a computation time deviation threshold; and defining an allocation scheme S={(j,Oⱼ)|j=1, . . . , M; k=1, . . . K}, wherein a specific checking method is as follows:
initializing a current allocation scheme S′={ }; for a j^{th} processor, finding a minimum value of |T_{k_j}−mid|, denoting a quantity k that is of self-attention heads and corresponds to the minimum value as Oⱼ, in other words, allocating the k self-attention heads to the j^{th} processor, and inserting (j,Oⱼ) into the S′; if the minimum value of the |T_{k_j}−mid| exceeds the specified threshold ε, setting Oⱼ=0; if a sum of all values of the Oⱼ is greater than or equal to K, it is indicated that the allocation scheme S′ is feasible, updating an original allocation scheme to the S′, and setting the upper bound r to mid−σ; or if a sum of all values of the Oⱼ is less than K, it is indicated that the allocation scheme is infeasible, updating the lower bound to mid+σ, and then re-searching for an allocation scheme, wherein σ represents a relatively small value to avoid an infinite loop; and terminating the iteration when l>r.

2. The distributed transformer-based LLM training method for the mobile device according to claim 1, wherein when a collaborative mobile device needs to exit the distributed training due to a dynamic event, the mobile device d_{q} sends a notification to the central mobile device in advance by α time; after receiving the notification, the central mobile device searches for an idle mobile device capable of participating in the training in the network through broadcasting; if there is no idle mobile device in the network, a conventional passive fault-tolerant recovery algorithm is used to perform fault-tolerant recovery on the training process; or each idle mobile device if available sends a computing power characterization vector and a remaining battery power percentage to the central mobile device, wherein a computing power characterization vector of a u^{th} idle mobile device is hᵤ, and a remaining battery power percentage of the u^{th} idle mobile device is bᵤ; the hᵤ characterizes computing power of the mobile device through a computation time of a transformer module, and is defined as hᵤ={t_{u,1}, t_{u,2}, . . . , t_{u,L}}, wherein t_{u,n} represents time required to compute n layers of transformers; and the bᵤ is a decimal between 0 and 1, with a larger value indicating more remaining battery power of the mobile device; and based on the hᵤ and the bᵤ, the central device evaluates compatibility of the idle mobile device based on a device compatibility (DC) criterion that is defined as follows:
$$D {C}_{u} = \frac{p * {\hat{b}}_{u}}{{\hat{H}}_{u} + η} ,$$
wherein DCᵤ represents the compatibility of the u^{th} idle device; p represents a percentage of a remaining training process, and is equal to [Bᵣ+(T−T_{cur})*B]*B/T, wherein T represents a total quantity of training rounds, B represents a total quantity of data batches, T_{cur} represents a current training round, and Bᵣ represents a remaining quantity of data batches in the current training round; η represents a small constant greater than 0; Ĥᵤ represents normalized computing power of the device, and is equal to (Hᵤ−Hₘᵢₙ)/(Hₘₐₓ−Hₘᵢₙ), wherein Hᵤ is obtained by summing all elements in the hᵤ, and Hₘₐₓ and Hₘᵢₙ respectively represent a maximum value and a minimum value among all values of the Hᵤ; and \hat{b}ᵤ represents normalized battery power of the device, and is equal to (bᵤ−bₘᵢₙ)/(bₘₐₓ−bₘᵢₙ), wherein bₘₐₓ represents a maximum value among all values of the bᵤ, and bₘᵢₙ represents a minimum value among all the values of the bᵤ; the central mobile device selects a mobile device dₛ with a largest DCᵤ value from a local area network to replace the mobile device d_{q}; subsequently, the training is temporarily interrupted, and the d_{q} transmits weights of a transformer sub-model to the dₛ; after the weights are completely transmitted, the central mobile device broadcasts a device replacement message to all devices participating in the training; and finally, the distributed training resumes normally.

3. The distributed transformer-based LLM training method for the mobile device according to claim 2, wherein the α time for sending the notification to the central mobile device in advance is longer than time required for the central device to select a most suitable replacement device from devices in the local area network.

4. The distributed transformer-based LLM training method for the mobile device according to claim 2, wherein the dynamic event of the mobile device comprises battery exhaustion and active exit from the local area network.

5. The distributed transformer-based LLM training method for the mobile device according to claim 1, wherein the mobile devices are intelligent terminals with computing capabilities, comprising mobile phones, watches, microcontrollers, cameras, laptops, and desktop computers.

6. The distributed transformer-based LLM training method for the mobile device according to claim 1, wherein processors of the mobile devices are chips with computing capabilities, comprising central processing units (CPUs), graphics processing units (GPUs), and neural network processing units (NPUs).
